(19) United States
(12) Patent Application Publication
(10) Pub. No.: US 2020/0128789 A1
(43) Pub. Date: Apr. 30, 2020

(54) PET HAIR GROOMING ASSEMBLY

(71) Applicants: Jamone Gates, Sacramento, CA (US); Miesha Gates, Sacramento, CA (US)

(72) Inventors: Jamone Gates, Sacramento, CA (US); Miesha Gates, Sacramento, CA (US)

(21) Appl. No.: 16/168,931

(22) Filed: Oct. 24, 2018

(51) Int. Cl. A01K 13/00; A46B 15/00

(52) U.S. Cl. CPC A01K 13/002; A46B 2200/1093; A46B 15/0053

(57) ABSTRACT

A pet hair grooming assembly for brushing and subsequently collecting pet hair includes a brush that can be manipulated for grooming pet hair. The brush has a first end, a second end and an outer wall extending therebetween. The first end is open to pass air inwardly therethrough and the brush is hollow. Additionally, the brush has a hair chamber therein for collecting pet hair. A brush head is removably coupled to the brush for brushing the pet hair and thusly dislodging loose pet hair. A suction unit is positioned in the brush. The suction unit urges air into the brush when the suction unit is turned on thereby facilitating the hair chamber to collect the loose pet pair.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to grooming devices and more particularly pertains to a new grooming device for brushing and subsequently collecting pet hair.

### BRIEF SUMMARY OF THE INVENTION

An embodiment of the disclosure meets the needs presented above by generally comprising a brush that can be manipulated for grooming pet hair. The brush has a first end, a second end and an outer wall extending therebetween. The first end is open to pass air inwardly therethrough and the brush is hollow. Additionally, the brush has a hair chamber therein for collecting pet hair. A brush head is removably coupled to the brush for brushing the pet hair and thusly dislodging loose pet hair. A suction unit is positioned in the brush. The suction unit urges air into the brush when the suction unit is turned on thereby facilitating the hair chamber to collect the loose pet pair.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded perspective view of a pet hair grooming assembly according to an embodiment of the disclosure.

FIG. 2 is a back view of an embodiment of the disclosure.

FIG. 3 is a front exploded view of an embodiment of the disclosure.

FIG. 4 is a cross sectional view taken along line 4-4 of FIG. 3 of an embodiment of the disclosure.

FIG. 5 is a bottom view of an embodiment of the disclosure.

FIG. 6 is a perspective in-use view of an embodiment of the disclosure.

### DETAILED DESCRIPTION OF THE INVENTION

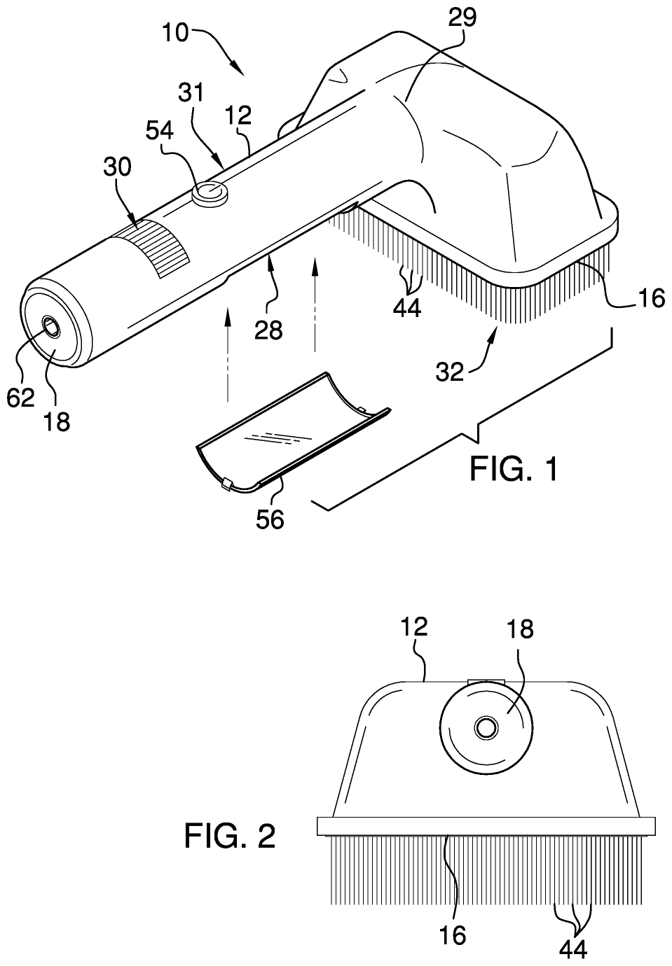

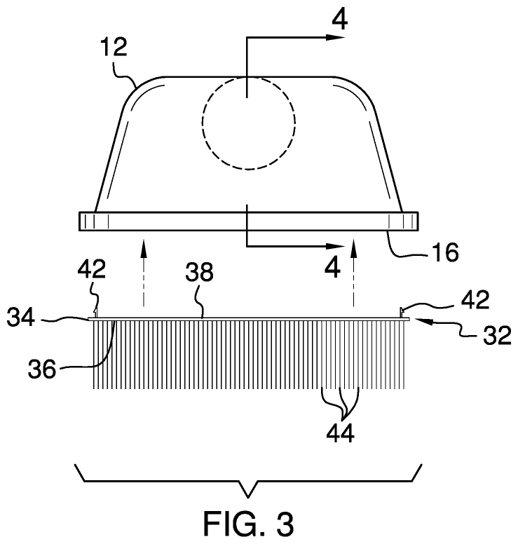

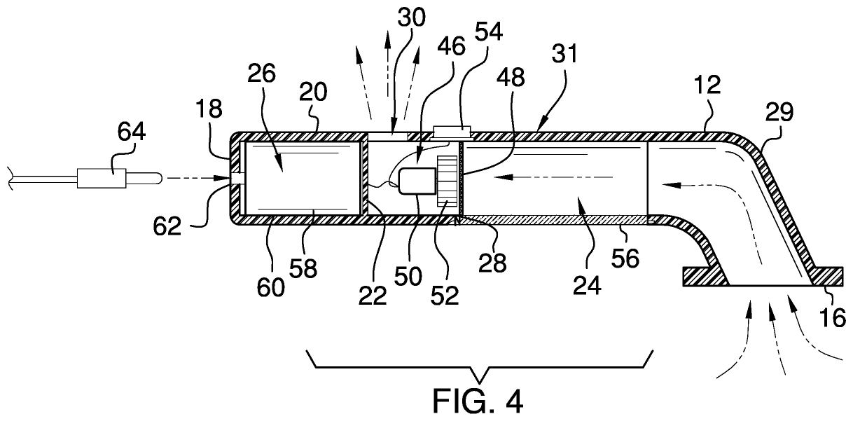

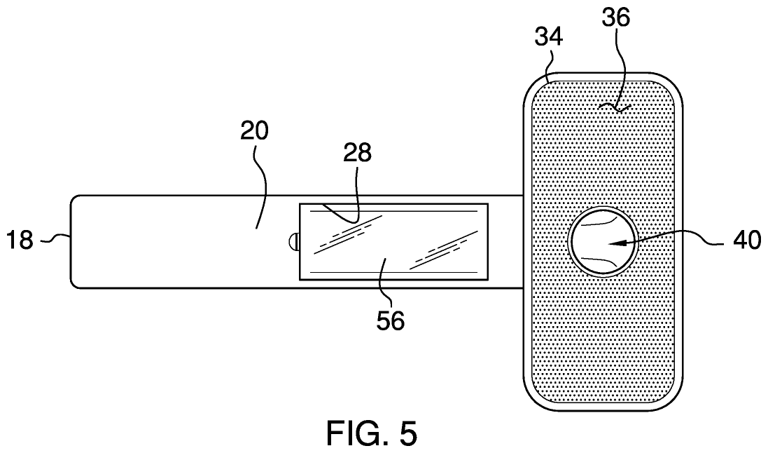

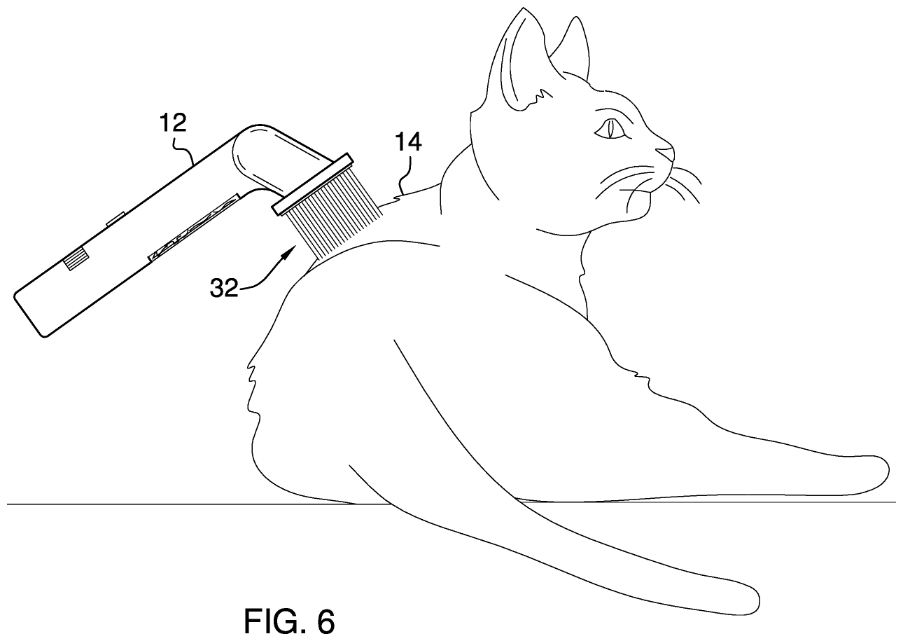

With reference now to the drawings, and in particular to FIGS. 1 through 6 thereof, a new grooming device embodying the principles and concepts of an embodiment of the disclosure and generally designated by the reference numeral 10 will be described.

As best illustrated in FIGS. 1 through 6, the pet hair grooming assembly 30 10 generally comprises a brush 12 that is manipulated for grooming pet hair 14. The brush 12 has a first end 16, a second end 18 and an outer wall 20 extending therebetween. The first end 16 is open to pass air inwardly therethrough and the brush 12 is hollow. The first end 16 flares outwardly from the outer wall 20 such that the first end 16 has a perimeter that is greater than a perimeter of the second end 18.

The brush 12 has a divider 22 positioned within the brush 12 to define a hair chamber 24 and a power supply chamber 26 within the brush 12. The hair chamber 24 extends between the first end 16 and the divider 22. The power supply chamber 26 extends between the second end 18 and the divider 22. The outer wall 20 has an opening 28 extending into the hair chamber 24 and the outer wall 20 has a vent 30 extending into the hair chamber 24. Additionally, the outer wall 20 has a bend 29 thereon adjacent to the first end 16 such that the first end 16 is directed downwardly from a handle section 31 of the brush 12.

A brush head 32 is removably coupled to the brush 12 for brushing the pet hair 14 and thusly dislodging loose pet hair 14. The brush head 32 comprises a panel 34 that has a first surface 36 and a second surface 38, and the second surface 38 abuts the first end 16 of the brush 12 when the panel 34 is positioned on the brush 12. The panel 34 has an air opening 40 extending through the first 36 and second 38 surfaces, and the air opening 40 in the panel 34 is centrally positioned on the panel 34. A pair of engagements 42 is each coupled to and extends away from the second surface 38 of the panel 34. Each of the engagements 42 releasably engages the first end 16 of the brush 12 when the panel 34 is positioned on the first end 16 for retaining the panel 34 on the first end 16. A plurality of bristles 44 is provided and each of the bristles 44 is coupled to and extends away from the first surface 36 of the panel 34 for brushing the pet hair 14. The bristles 44 are spaced apart from each other and are distributed over an entirety of the first surface 36 of the panel 34.

A suction unit 46 is provided and the suction unit 46 is positioned in the brush 12. The suction unit 46 urges air into the brush 12 when the suction unit 46 is turned on. In this way the hair chamber 24 can collect the loose pet pair. The suction unit 46 comprises a screen 48 that is positioned within the hair chamber 24 and the screen 48 is positioned between the first end 16 of the brush 12 and the divider 22. Additionally, the screen 48 is comprised of a fluid permeable material to pass air therethrough.

A motor 50 is positioned between the screen 48 and the divider 22, and a fan 52 is rotatably coupled to the motor 50. The fan 52 urges air inwardly through the air opening 40 in the panel 34 and outwardly through the vent 30 in the brush 12 when the motor 50 is turned on. In this way the fan 52 sucks the loose pet hair 14 into the hair chamber 24 when the pet hair 14 is brushed. The fan 52 may be a cross flow, radial fan or the like for reducing noise produced by the fan 52. In this way the fan 52 reduces stress in the pet that could potentially be caused by the loud noise of a vacuum cleaner or other suction source. A switch 54 is coupled to the outer wall 20 of the brush 12 and the switch 54 is electrically coupled to the motor 50 for turning the motor 50 on and off.

A cover 56 is removably coupled to the brush 12. The cover 56 is aligned with the opening 28 extending into the hair chamber 24 when the cover 56 is coupled to the brush 12. In this way the cover 56 contains the loose pet hair 14 in the hair chamber 24. The cover 56 is removed from the outer wall 20 to empty the hair chamber 24. Additionally, the cover 56 may be comprised of a translucent material thereby facilitating the loose pet hair 14 to be visible in the hair chamber 24.

A power supply 58 is coupled to the brush 12 and the power supply 58 is electrically coupled to the suction unit 46. The power supply 58 comprises at least one battery 60 that is positioned in the power supply chamber 26 and the at least one battery 60 is electrically coupled to the switch 54. A charge port 62 is coupled to the second end 18 of the brush 12. The charge port 62 is electrically coupled to the at least one battery 60 for charging the at least one battery 60. Additionally, the charge port 62 is selectively electrically coupled to a power source 64, such as a battery 60 charger or the like. The charge port 62 can supply electrical power to the motor 50 when the charge port 62 is electrically coupled to the power source 64.

In use, the switch 54 on the brush 12 is manipulated to turn on the motor 50 and the brush 12 is manipulated to brush 12 the pet. The bristles 44 on the brush head 32 dislodge the loose pet hair 14 and the loose pet hair 14 is sucked upwardly through the air opening 28 in the panel 34 of the brush head 32. Thus, the loose pet hair 14 is collected in the hair chamber 24 while the pet is brush 12ed. The cover 56 is removed from the brush 12 when the hair chamber 24 becomes filled with the loose pet hair 14 thereby facilitating the chamber to be emptied.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pet hair grooming assembly being configured to suck pet hair therein during grooming, said assembly comprising:
a brush being manipulated for grooming pet hair, said brush having a first end, a second end and an outer wall extending therebetween, said first end being open wherein said first end is configured to pass air inwardly therethrough, said brush being hollow, said brush having a hair chamber therein for collecting pet hair;
a brush head removably coupled to said brush wherein said brush head is configured to brush the pet hair and thusly dislodge loose pet hair; and
a suction unit being positioned in said brush, said suction unit urging air into said brush when said suction unit is turned on wherein said hair chamber is configured to collect the loose pet pair.

2. The assembly according to claim 1, wherein:
said first end of said brush flares outwardly from said outer wall such that said first end has a perimeter being greater than a perimeter of said second end;
said brush has a divider being positioned within said brush to define said hair chamber and a power supply chamber within said brush, said hair chamber extending between said first end and said divider, said power supply chamber extending between said second end and said divider;
said outer wall having an opening extending into said hair chamber; and
said outer wall having a vent extending into said hair chamber.

3. The assembly according to claim 2, wherein said brush head comprises:
a panel having a first surface and a second surface, said second surface abutting said first end of said brush when said panel is positioned on said brush, said panel having an air opening extending through said first and second surfaces, said air opening in said panel being centrally positioned on said panel;
a pair of engagements, each of said engagements being coupled to and extending away from said second surface of said panel, each of said engagements releasably engaging said first end of said brush when said panel is positioned on said first end for retaining said panel on said first end; and
a plurality of bristles, each of said bristles being coupled to and extending away from said first surface of said panel wherein each of said bristles is configured to brush the pet hair, said bristles being spaced apart from each other and being distributed over an entirety of said first surface of said panel.

4. The assembly according to claim 2, wherein said suction unit comprises a screen being positioned within said hair chamber, said screen being positioned between said first end of said brush and said divider, said screen being comprised of a fluid permeable material wherein said screen is configured to pass air therethrough.

5. The assembly according to claim 4, wherein said suction unit comprises:
a motor being positioned between said screen and said divider;
a fan being rotatably coupled to said motor, said fan urging air inwardly through said air opening in said panel and outwardly through said vent in said brush when said motor is turned on wherein said fan is configured to suck the pet hair into said hair chamber; and
a switch being coupled to said outer wall of said brush, said switch being electrically coupled to said motor for turning said motor on and off.

6. The assembly according to claim 2, further comprising a cover being removably coupled to said brush, said cover being aligned with said opening extending into said hair chamber when said cover is coupled to said brush wherein said cover is configured to contain the pet hair in said hair chamber, said cover being removed from said outer wall to empty said hair chamber.

7. The assembly according to claim 5, further comprising a power supply being coupled to said brush, said power supply being electrically coupled to said suction unit.

8. The assembly according to claim 7, wherein said power supply comprises:
at least one battery being positioned in said power supply chamber, said at least one battery being electrically coupled to said switch; and
a charge port being coupled to said second end of said brush, said charge port being electrically coupled to said at least one battery for charging said at least one battery, said charge port being selectively electrically coupled to a power source.

9. A pet hair grooming assembly being configured to suck pet hair therein during grooming, said assembly comprising:
a brush being manipulated for grooming pet hair, said brush having a first end, a second end and an outer wall extending therebetween, said first end being open wherein said first end is configured to pass air inwardly therethrough, said brush being hollow, said first end flaring outwardly from said outer wall such that said first end has a perimeter being greater than a perimeter of said second end, said brush having a divider being positioned within said brush to define a hair chamber and a power supply chamber within said brush, said hair chamber extending between said first end and said divider, said power supply chamber extending between said second end and said divider, said outer wall having an opening extending into said hair chamber, said outer wall having a vent extending into said hair chamber;
a brush head removably coupled to said brush wherein said brush head is configured to brush the pet hair and thusly dislodge loose pet hair, said brush head comprising:
a panel having a first surface and a second surface, said second surface abutting said first end of said brush when said panel is positioned on said brush, said panel having an air opening extending through said first and second surfaces, said air opening in said panel being centrally positioned on said panel;
a pair of engagements, each of said engagements being coupled to and extending away from said second surface of said panel, each of said engagements releasably engaging said first end of said brush when said panel is positioned on said first end for retaining said panel on said first end; and
a plurality of bristles, each of said bristles being coupled to and extending away from said first surface of said panel wherein each of said bristles is configured to brush the pet hair, said bristles being spaced apart from each other and being distributed over an entirety of said first surface of said panel;
a suction unit being positioned in said brush, said suction unit urging air into said brush when said suction unit is turned on wherein said hair chamber is configured to collect the loose pet pair, said suction unit comprising:
a screen being positioned within said hair chamber, said screen being positioned between said first end of said brush and said divider, said screen being comprised of a fluid permeable material wherein said screen is configured to pass air therethrough;
a motor being positioned between said screen and said divider;
a fan being rotatably coupled to said motor, said fan urging air inwardly through said air opening in said panel and outwardly through said vent in said brush when said motor is turned on wherein said fan is configured to suck the pet hair into said hair chamber; and
a switch being coupled to said outer wall of said brush, said switch being electrically coupled to said motor for turning said motor on and off;
a cover being removably coupled to said brush, said cover being aligned with said opening extending into said hair chamber when said cover is coupled to said brush wherein said cover is configured to contain the pet hair in said hair chamber, said cover being removed from said outer wall to empty said hair chamber; and
a power supply being coupled to said brush, said power supply being electrically coupled to said suction unit, said power supply comprising:
at least one battery being positioned in said power supply chamber, said at least one battery being electrically coupled to said switch; and
a charge port being coupled to said second end of said brush, said charge port being electrically coupled to said at least one battery for charging said at least one battery, said charge port being selectively electrically coupled to a power source.
